(19) United States
(12) Patent Application Publication
(10) Pub. No.: US 2015/0358906 A1
(43) Pub. Date: Dec. 10, 2015

(54) ELECTRONIC DEVICE WITH POWER MANAGEMENT, ASSOCIATED METHOD AND NON-TRANSITORY COMPUTER-READABLE MEDIUM

(71) Applicant: Mediatek Inc., Hsin-Chu (TW)

(72) Inventors: Kuo-Pin Chiou, Hsinchu City (TW); Cheng-Lung Tsai, Chiayi County (TW)

(21) Appl. No.: 14/720,978

(22) Filed: May 26, 2015

Related U.S. Application Data
(60) Provisional application No. 62/009,510, filed on Jun. 9, 2014.

(51) Int. Cl. H04W 52/02; H04W 12/06; H04W 48/16

(52) U.S. Cl. CPC H04W 52/0225; H04W 48/16; H04W 12/06

(57) ABSTRACT

An electronic device and an associated method are provided. The electronic device includes a wireless circuit and a controller. The wireless circuit is arranged to provide a soft access point. The controller is arranged to detect whether there is at least one client trying to connect to the soft access point when the electronic device operates in a sleep mode; and allow the electronic device to enter a working mode from the sleep mode when detecting that there is at least one client trying to connect to the soft access point.

### CROSS REFERENCE TO RELATED APPLICATIONS

This application claims the benefit of U.S. provisional application No. 62/009,510, filed on Jun. 9, 2014 and incorporated herein by reference.

### BACKGROUND

The disclosed embodiments of the present invention relate to power management within a wireless environment, and more particularly, to an electronic device capable of dynamically adjusting power consumption based on received client requests, an associated method and a non-transitory computer-readable medium thereof.

In a wireless networking environment, an access point (AP) is arranged to provide access to the internet for mobile devices through wireless communications. It may occur, however, that there is only a wired network available. In order to provide the internet for mobile devices, a software-based access point (Soft AP) has been developed. A Soft AP maybe implemented with appropriate driver software running on an electronic device in order to provide functions identical/similar to those possessed by a typical hardware-based access point.

The soft AP is able to share the internet in a wired network only environment. A user may utilize a laptop computer to convert a wired network provided by a hotel, for example, into a soft AP, to therefore provide the internet for her own mobile device. Hence, the user may link her mobile device to the soft AP to use the wireless network.

Some issues may be encountered when using the soft AP. According to an IEEE 802.11 specification, it is assumed that the electronic device providing the soft AP is “always on”, or always able to respond to appropriate signals from users seeking to link to the network through the provided soft AP. Even if the user leaves the soft AP, making the soft AP and her mobile device disconnected, the laptop computer will remain the soft AP and thus will not enter a sleep mode. This will cause unnecessary power consumption.

Further, although the laptop computer running the soft AP may be forced to enter the sleep mode when detecting that the current user leaves the soft AP, the soft AP will also be disabled in such a case. If the user wants to recover the connection for her mobile device, she must manually wake up the operating system (OS) of the laptop computer, e.g. through clicking the keyboard or mouse, so that the laptop computer enters the working mode and starts to rebuild the soft AP. This will negatively affect the user's experience.

Therefore, there is a need for a novel method to improve the power management of an electronic device running a soft AP.

### SUMMARY

In accordance with exemplary embodiments of the present invention, an electronic device with enhanced power management, an associated method and a non-transitory computer-readable medium are proposed.

An objective of the present invention is to provide an electronic device and an associated method for allowing the electronic device running a soft AP to enter a sleep mode when no peripheral device uses the wireless network provided by the soft AP, and recovering the wireless network when there is at least one peripheral device seeking to link the wireless network, to solve the above-mentioned issues.

An embodiment of the present invention provides an electronic device, which includes a wireless circuit and a controller. The wireless circuit is arranged to provide a soft access point (AP). The controller is arranged to detect whether there is at least one client trying to connect to the soft AP when the electronic device operates in a sleep mode; and allow the electronic device to enter a working mode from the sleep mode when detecting that there is at least one client trying to connect to the soft AP.

Another embodiment of the present invention provides a method for controlling an electronic device with a wireless circuit arranged to provide a soft AP. The method includes the following steps: detecting whether there is at least one client trying to connect to the soft AP when the electronic device operates in a sleep mode; and controlling the electronic device to enter a working mode from the sleep mode when detecting that there is at least one client trying to connect to the soft AP.

Yet another embodiment of the present invention provides a non-transitory computer-readable medium storing a program code. When the non-transitory computer-readable medium is executed by an electronic device with a wireless circuit arranged to provide a soft AP, the program code allows the electronic device to perform the following steps: detecting whether there is at least one client trying to connect to the soft AP when the electronic device operates in a sleep mode; and controlling the electronic device to enter a working mode from the sleep mode when detecting that there is at least one client trying to connect to the soft AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device applied to a wireless environment according to an embodiment of the present invention.

FIG. 2 is a diagram illustrating a finite state machine employed by the electronic device shown in FIG. 1 according to an embodiment of the present invention.

FIG. 3 is a flowchart illustrating a method arranged for controlling an electronic device with a wireless circuit arranged to provide a soft AP according to an embodiment of the present invention.

FIG. 4 is a diagram illustrating a software-based implementation of the controller shown in FIG. 1 according to an embodiment of the present invention.

FIG. 5 is a diagram illustrating the operations of a laptop PC according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

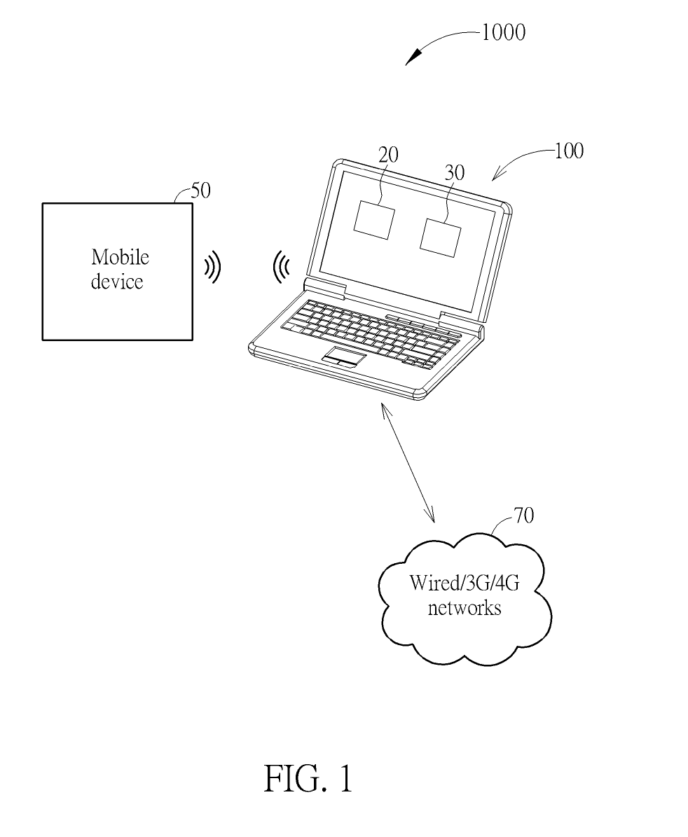

FIG. 1 is a diagram illustrating an electronic device 100 applied to a wireless environment 1000 according to an embodiment of the present invention. The electronic device 100 includes a wireless circuit 20 and a controller 30. The wireless circuit 20 is arranged to provide a soft access point (AP) via a wired network 70. The controller 30 is arranged to detect the existence of nearby clients, such as various kinds of mobile devices. It should be noted that only the circuit components pertinent to the present invention are shown in FIG. 1. In practice, the electronic device 100 may include additional circuit components to achieve other functions. In IEEE 802.11 standard, only the client side can scan and detect an AP. The AP side does not scan so that the AP side does not know whether there are client, unless they connect to the AP side.

In the exemplary connectivity scenario shown in FIG. 1, the soft AP is provided via software to allow electronic device 100 to operate as a wireless AP. Hence, the mobile device 50 accesses the network through the soft AP provided by the electronic device 100. By way of example, not limitation, the electronic device 100 may be a laptop computer, and the mobile device 50 maybe a multimedia player, a mobile phone, a tablet, or a wearable device. Please note that, in some modifications of the present invention, the electronic device 100 may be a desktop computer.

When the electronic device 100 operates in a sleep mode, the controller 30 may be arranged to detect whether there is at least one client trying to connect to the soft AP. For example, when the electronic device 100 is in the sleep mode, part of the elements of the wireless circuit 20 may remain awake, so as to broadcast beacons to the mobile device 50. In IEEE802.11 standard, AP broadcasts a beacon every 100 ms. The purpose of this setting is to let clients find the AP via scanning. The authentication Request is sent from a client when the client intends to connect to an AP. In this invention, if there is no client connecting to the soft AP, the laptop PC will keep sleeping. Please note that if the user manually disables the system power save, the controller 30 shall not force the system to enter the sleep mode. Further, if a client intends to connect to the soft AP, the WiFi firmware will wake up the laptop PC. Moreover, when the laptop PC is in the sleep mode, it cannot share wired/3G/4G internets to the soft AP because the system is in the sleep mode. In other words, the client side cannot access the internet even when it has connected to the soft AP. If the client wants to access the internet, the laptop PC needs to be waked up and then may share its internet to the soft AP. Please note that, although there is only one peripheral device (i.e. mobile device 50) shown in FIG. 1, the electronic device 100 may be used to detect the existence of a plurality of nearby peripheral devices in another scenario.

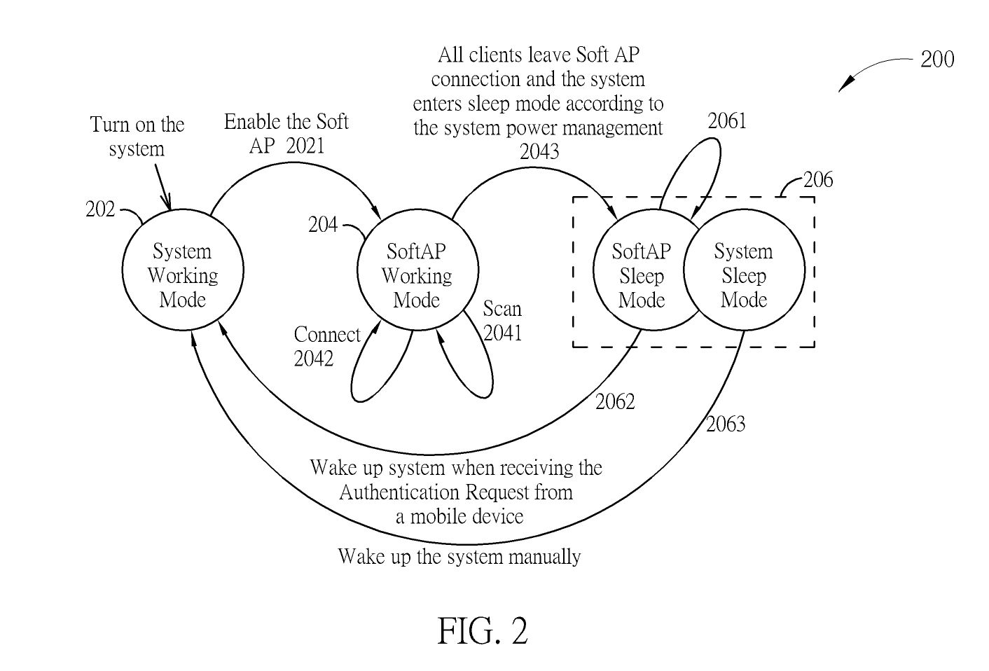

Refer to FIG. 2, which is a diagram illustrating a finite state machine (FSM) 200 employed by the electronic device 100 shown in FIG. 1 according to an embodiment of the present invention. As shown in FIG. 2, State 202 represents a system working mode of the electronic device 100, State 204 represents a soft AP working mode, and State 206 represents a soft AP sleep mode as well as a system sleep mode of the electronic device 100. The detailed operations of the FSM 200 are as follows.

The electronic device 100 may be initially turned on (or powered on) at State 202. Then, based on a default setting or a user-defined setting, the electronic device 100 may enter State 204 from State 202, to enable the soft AP (Step 2021). After the soft AP is created, the soft AP can be scanned/connected by clients, and work as a normal WiFi AP. Next, when detecting that there is at least one client still connected to the soft AP, the controller 30 will allow the electronic device 100 to stay in the working mode (i.e. stay in State 202); and when detecting that there is no client connected to the soft AP, for better system power management, the controller 30 will allow the electronic device 100 to enter State 206 from State 204 (i.e. enter the sleep mode from the working mode) (Step 2043), so as to reduce power consumption. State 206 is depicted in a dual circle to show that the soft AP and the electronic device 100 may be viewed as substantially entering the sleep mode at the same time. This is because the sleep mode of the electronic device 100 may directly lead the soft AP to the sleep mode. For instance, if the system enters the sleep mode, some devices/elements of the system will also enter the sleep mode. The left part of the dual circle represents the sleep mode of the soft AP, and the right part of the dual circle represents the sleep mode of the electronic device 100. Please note that all of the elements of the wireless circuit 20 may be disabled in State 206; however, the present invention is not limited thereto. In some modifications of the present invention, part of the elements of the wireless circuit 20 of the electronic device 100 may remain awake, to broadcast beacons to the mobile device 50, and receive an authentication request from the mobile device 50. When the electronic device 100 operates in the sleep mode, the controller 30 may control the soft AP to broadcast a beacon signal for a plurality of times. That is, the frequency of broadcasting each beacon can be adjusted based on the actual design requirements.

In Step 2061, some elements of the wireless circuit 20 remaining awake may keep monitoring clients trying to connect to the soft AP. Some built-in hardware or firmware of the electronic device 100 may be used to replace these elements, so that all elements of the wireless circuit 20 can be disabled.

When it is detected that there is at least one client trying to connect to the soft AP, e.g. when part of the elements of the wireless circuit 20 which remain awake are informed by the authentication request, State 206 may be switched to State 202 (Step 2062). That is, the electronic device 100 will be awakened by the wireless circuit 20 or the built-in hardware or firmware, so as to provide the soft AP to the client. More specifically, the controller 30 may determine that there is a client trying to connect to the soft AP when the soft AP receives an authentication request from the client that receives the beacon signal. Otherwise (i.e. when it is detected that there is no client trying to connect to the soft AP), the electronic device 100 stays in State 206. Further, it is also possible that a user switches from State 206 to State 202 by manually awakening the electronic device 100 (Step 2063), e.g. through touching the mouse or keyboard.

It should be noted that, when the electronic device 100 operates in the working mode, the soft AP running on the wireless circuit 20 has a first power consumption; and when the electronic device 100 operates in the sleep mode, the soft AP running on the wireless circuit has a second power consumption lower than the first power consumption. Through utilizing the proposed methods and means of the present invention, the working/sleep state of an electronic device (e.g. a laptop computer) may be adaptively switched based on the use of the soft AP, to implement better power management without negatively affecting the user experience.

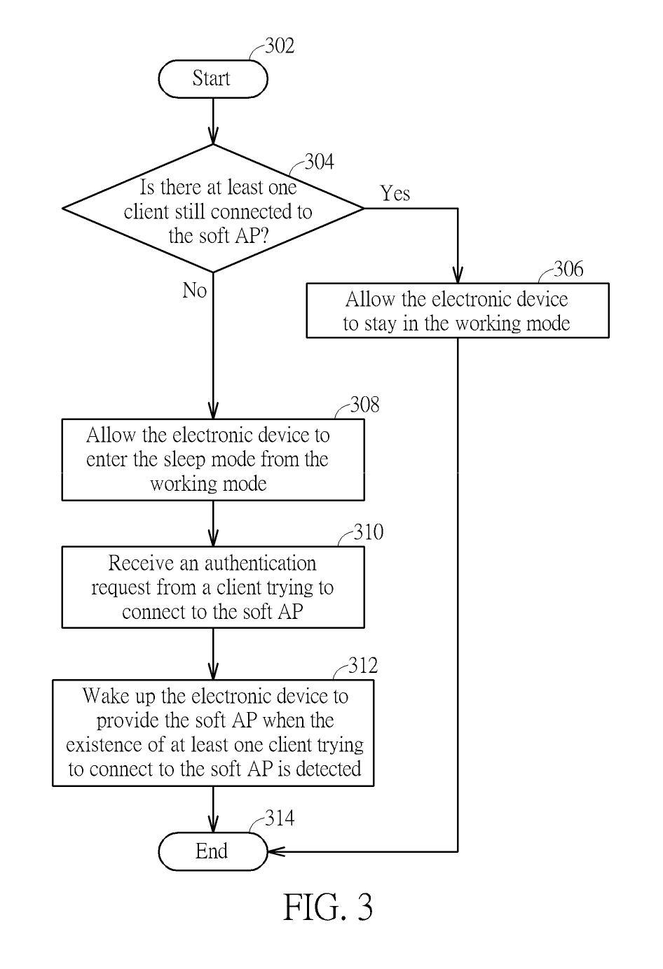

Refer to FIG. 3, which is a flowchart illustrating a method arranged for controlling an electronic device with a wireless circuit arranged to provide a soft AP according to an embodiment of the present invention. If the result is substantially the same, the steps are not required to be executed in the exact order shown in FIG. 3. The exemplary method shown in FIG. 3 may be employed by the electronic device 100 shown in FIG. 1 and may be applied to operate the FSM 200 shown in FIG. 2, and may be briefly summarized as follows.

Step 302: Start.

Step 304: Detect whether there is at least one client still connected to the soft AP when the electronic device operates in a working mode. When it is detected that there is at least one client still connected to the soft AP, go to step 306; otherwise (when it is detected that there is no client connected to the soft AP), go to step 308.

Step 306: Allow the electronic device to stay in the working mode, and then go to step 314.

Step 308: Allow the electronic device to enter the sleep mode from the working mode (based on its system power management).

Step 310: Receive an authentication request from a client trying to connect to the soft AP.

Step 312: Wake up the electronic device to provide the soft AP when the existence of at least one client trying to connect to the soft AP is detected.

Step 314: End.

As one skilled in the art can readily understand details of each step shown in FIG. 3 after reading above paragraphs directed to the electronic device 100 shown in FIG. 1 and the FSM 200 shown in FIG. 2, further description is omitted here for brevity.

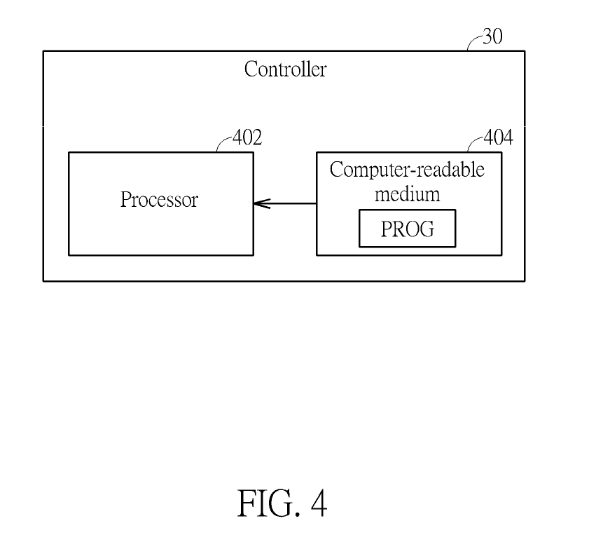

As well as the electronic device 100 shown in FIG. 1 and the FSM 200 shown in FIG. 2, the present invention further proposes a non-transitory computer-readable medium which stores a program code. In one exemplary design, the controller 30 shown in FIG. 1 may be implemented using pure hardware. Alternatively, the controller 30 may be software-based. FIG. 4 is a diagram illustrating a software-based implementation of the controller shown in FIG. 1 according to an embodiment of the present invention. As shown in FIG. 4, the controller 30 has a processor 402 and a computer-readable medium 404. For example, the computer-readable medium 404 may be a non-volatile memory such as a flash memory. The computer-readable medium 404 is arranged to store a program code PROG. When the program code PROG is loaded and executed by the electronic device 100 (in particular, the processor 402 of the controller 30), the program code PROG allows the electronic device 100 to perform at least the following steps: detecting whether there is at least one client trying to connect to the soft AP when the electronic device operates in a sleep mode; and controlling the electronic device to enter a working mode from the sleep mode when detecting that there is at least one client trying to connect to the soft AP. Similarly, as one skilled in the art can readily understand detailed usages of the proposed non-transitory computer-readable medium after reading the above paragraphs directed to the electronic device 100 shown in FIG. 1 and the FSM 200 shown in FIG. 2, further description is omitted here for brevity.

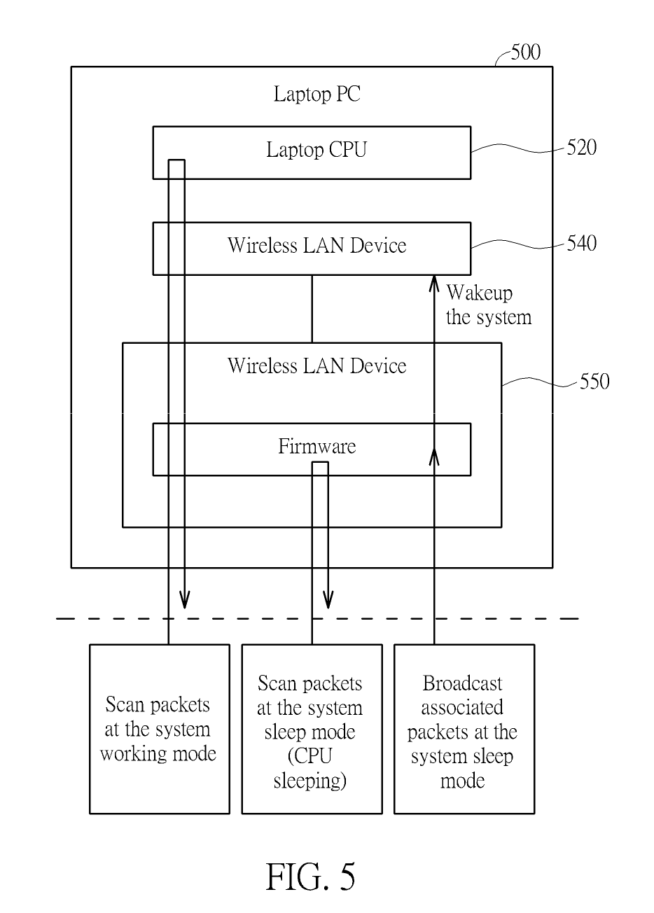

FIG. 5 is a diagram illustrating the operations of a laptop PC 500 according to an embodiment of the present invention. The laptop PC 500 includes a laptop CPU 520, a first wireless LAN device 540, and a second LAN device 550 and, wherein the second LAN device 550 includes the firmware 560. Block 501 shows the operation of scanning packets at the system working mode, Block 502 shows the operation of scanning packets at the system sleep mode, and Block 503 shows the operation of waking up the system via broadcasting associated packets at the system sleep mode. It can be seen from Blocks 501 and 502 that the packets may be scanned no matter the laptop CPU 520 is in the sleep mode or the working mode. For example, when the laptop CPU 520 is in the sleep mode, packets may be scanned from the firmware 560 of the second LAN device 550. Further, when the laptop CPU 520 is in the sleep mode, the laptop CPU 520 may still be waked up by breasting associated packets to the first wireless LAN device 540.

To summarize, the embodiments of the present invention disclose an electronic device, an associated method and a non-transitory computer-readable medium capable of reducing the power consumption thereof and improving the user experience. With the aid of the present invention, when the soft AP and the electronic device are both in the sleep mode, the electronic device maybe automatically awakened rather than being manually awakened, which facilitates the use of the soft AP. Hence, the user may avoid having to manually control the working state of an electronic device when the electronic device with Soft AP functionality employs the proposed control method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a wireless circuit, arranged to provide a soft access point (AP); and
a controller, arranged to detect whether there is at least one client trying to connect to the soft AP when the electronic device operates in a sleep mode; and allow the electronic device to enter a working mode from the sleep mode when detecting that there is at least one client trying to connect to the soft AP.

2. The electronic device of claim 1, wherein the controller allows the electronic device to enter the sleep mode from the working mode when detecting that there is no client connected to the soft AP

3. The electronic device of claim 1, wherein the controller controls the electronic device to stay in the working mode when detecting that there is at least one client still connected to the soft AP.

4. The electronic device of claim 1, wherein when the electronic device operates in the sleep mode, the controller controls the soft AP to keep broadcasting beacon signals, for a client to scan the soft AP.

5. The electronic device of claim 4, wherein the controller determines that there is a client trying to connect to the soft AP when the soft AP receives an authentication request from the client that receives the beacon signal.

6. The electronic device of claim 1, wherein when the electronic device operates in the working mode, the soft AP running on the wireless circuit has a first power consumption; and when the electronic device operates in the sleep mode, the soft AP running on the wireless circuit has a second power consumption lower than the first power consumption.

7. A method for controlling an electronic device with a wireless circuit arranged to provide a soft access point (AP), the method comprising:
when the electronic device operates in a sleep mode, detecting whether there is at least one client trying to connect to the soft AP; and
allowing the electronic device to enter a working mode from the sleep mode when detecting that there is at least one client trying to connect to the soft AP.

8. The method of claim 7, further comprising:
allowing the electronic device to enter the sleep mode from the working mode when detecting that there is no client connected to the soft AP.

9. The method of claim 7, further comprising:
controlling the electronic device to stay in the working mode when detecting that there is at least one client still connected to the soft AP.

10. The method of claim 7, wherein the step of detecting whether there is at least one client trying to connect to the soft AP comprises:
controlling the soft AP to keep broadcasting beacon signals, for a client to scan the soft AP.

11. The method of claim 10, wherein the step of detecting whether there is at least one client trying to connect to the soft AP further comprises:
when the soft AP receives an authentication request from a client that receives the beacon signal, determining that the client is trying to connect to the soft AP.

12. The method of claim 7, further comprising:
when the electronic device operates in the working mode, controlling the soft AP running on the wireless circuit to have a first power consumption; and
when the electronic device operates in the sleep mode, controlling the soft AP running on the wireless circuit to have a second power consumption lower than the first power consumption.

13. A non-transitory computer-readable medium storing a program code, wherein when executed by an electronic device with a wireless circuit arranged to provide a soft access point (AP), the program code controls the electronic device to perform the following steps:
when the electronic device operates in a sleep mode, detecting whether there is at least one client trying to connect to the soft AP; and
controlling the electronic device to enter a working mode from the sleep mode when detecting that there is at least one client trying to connect to the soft AP.

14. The non-transitory computer-readable medium of claim 13, wherein the program code further allows the electronic device to perform the following step:
enter the sleep mode from the working mode when detecting that there is no client connected to the soft AP.

15. The non-transitory computer-readable medium of claim 13, wherein the program code further controls the electronic device to perform the following step:
staying in the working mode when detecting that there is at least one client still connected to the soft AP.

16. The non-transitory computer-readable medium of claim 13, wherein the step of detecting whether there is at least one client trying to connect to the soft AP comprises:
controlling the soft AP to keep broadcasting beacon signals.

17. The non-transitory computer-readable medium of claim 16, wherein the step of detecting whether there is at least one client trying to connect to the soft AP further comprises:
when the soft AP receives an authentication request from a client that receives the beacon signal, determining that the client is trying to connect to the soft AP.

18. The non-transitory computer-readable medium of claim 13, wherein the program code further controls the electronic device to perform the following steps:
when the electronic device operates in the working mode, controlling the soft AP running on the wireless circuit to have a first power consumption; and
when the electronic device operates in the sleep mode, controlling the soft AP running on the wireless circuit to have a second power consumption lower than the first power consumption.
